(19) United States
(12) Patent Application Publication
(10) Pub. No.: US 2023/0031684 A1
(43) Pub. Date: Feb. 2, 2023

(54) BATTERY-TYPE ELECTROCHEMICAL DEVICE COMPRISING IMPROVED SEALING MEANS AND METHOD FOR MANUFACTURING SAME

(71) Applicant: I-TEN, Dardilly (FR)

(72) Inventors: Fabien Gaben, Dardilly (FR); Ian CAYREFOURCQ, Villefontaine (FR)

(21) Appl. No.: 17/788,507

(22) PCT Filed: Dec. 23, 2020
(86) PCT No.: PCT/IB2020/062375

§ 371 Date: Jun. 23, 2022

(30) Foreign Application Priority Data
Dec. 24, 2019 (FR) 1915566

(51) Int. Cl. H01M 50/186; H01M 10/0585; H01M 10/42

(52) U.S. Cl. CPC H01M 50/186; H01M 10/0585; H01M 10/425

(57) ABSTRACT

A battery-type of electrochemical device including a unit stack formed by at least one unit cell, an electrical connection support, made at least in part of a conductive material, provided near a first frontal face of the unit stack, electrical insulation means enabling two distant regions of the electrical connection support to be insulated from one another, anode contact means enabling a first lateral face of the unit stack to be electrically connected to the electrical connection support, cathode contact means enabling a second lateral face of the unit stack to be electrically connected to the electrical connection support, an encapsulation system covering the other frontal face of the unit stack, the anode contact means, the cathode contact means, and at least in part the face of the electrical connection support that is facing the unit stack, and a mechanical stiffening system covering the encapsulation system opposite the electrical connection support.

### CROSS-REFERENCE TO RELATED APPLICATIONS

The present application is a National Stage Application of PCT International Application No. PCT/IB2020/062375 (filed on Dec. 23, 2020), under 35 U.S.C. § 371, which claims priority to French Patent Application No. 1915566 (filed on Dec. 24, 2019), which are each hereby incorporated by reference in their complete respective entireties.

### TECHNICAL FIELD

The present invention relates to electrochemical devices of the battery type. It can in particular be applied to lithium-ion batteries. The invention relates to a novel battery architecture, which gives batteries improved impervious sealing properties. The invention further relates to a method for manufacturing these batteries.

### BACKGROUND

Some types of batteries, an in particular some types of thin-film batteries, need to be encapsulated in order to have a long life because oxygen and water (H₂O) in the gas phase cause degradation thereto. In particular, lithium-ion batteries are very sensitive to water in the gas phase. The market demands a product life of more than 10 years; an encapsulation must thus be provided to guarantee this life.

Thin-film lithium-ion batteries are multi-layer stacks comprising electrode and electrolyte layers typically between about one μm and about ten μm thick. They can comprise a stack of a plurality of unit cells. These solid-state thin-film lithium-ion batteries usually use anodes having a lithium metal layer.

The active materials of lithium-ion batteries are very sensitive to air and in particular to water in the gas phase. Mobile lithium ions react spontaneously with traces of water to form LiOH, resulting in calendar ageing of the batteries. All lithium ion-conductive electrolytes and insertion materials are non-reactive to moisture. By way of example, Li₄Ti₅O₁₂ does not deteriorate when in contact with the atmosphere or traces of water. By contrast, as soon as it is filled with lithium in the form Li₄₊ₓTi₅O₁₂, where x>0, the inserted lithium surplus (x) is sensitive to the atmosphere and reacts spontaneously with traces of water to form LiOH. The reacted lithium is thus no longer available for storing electricity, resulting in a loss of capacity of the battery.

To prevent exposure of the active materials of the lithium-ion battery to air and water and to prevent this type of ageing, it must be protected with an encapsulation system. Numerous encapsulation systems for thin-film batteries are described in the literature.

U.S. Patent Publication No. 2002/0071989 describes an encapsulation system for a solid-state thin-film battery comprising a stack of a first layer of a dielectric material selected from among alumina (Al₂O₃), silica (SiO₂), silicon nitride (Si₃N₄), silicon carbide (SiC), tantalum oxide (Ta₂O₅) and amorphous carbon, a second layer of a dielectric material and an impervious sealing layer disposed on the second layer and covering the entire battery.

U.S. Pat. No. 5,561,004 describes a plurality of systems for protecting a thin-film lithium-ion battery. A first proposed system comprises a parylene layer covered with an aluminium film deposited on the active components of the battery. However, this system for protecting against air and water vapour diffusion is only effective for about a month. A second proposed system comprises alternating layers of parylene (500 nm thick) and metal (about 50 nm thick). The document states that it is preferable to coat these batteries again with an ultraviolet-cured (UV-cured) epoxy coating to reduce the speed at which the battery is degraded by atmospheric elements.

Reference is also made to the French Patent Publication No. FR-A-3 068 830, filed by Applicant, which describes a typical arrangement of an electrochemical device. As described in this document, such a device comprises a unit stack, each cell whereof comprises anode and respectively cathode current-collecting substrates, anode and respectively cathode layers, and at least one layer of an electrolyte material or of a separator impregnated with an electrolyte. Anode and respectively cathode contacts are provided on the opposing lateral faces of this stack.

Finally, reference is made to the International Patent Publication No. WO-A-2016/025 067, which describes a battery whose stack is at rest on a substrate in which orifices have been made. These allow electrically conductive members connected, respectively, to the anode and cathode, to be received. A polymer layer and an outer impervious sealing layer are provided opposite the substrate. This document does not provide a satisfactory solution, primarily in terms of imperviousness. More specifically, the outer layer does not satisfactorily procure the desired barrier function thereof. Moreover, this hermetically-sealed layer is situated on the outside, making it fragile and susceptible to deterioration. This document thus also does not provide satisfactory teachings in terms of mechanical stiffness.

According to the prior art, most lithium-ion batteries are encapsulated in metallised polymer foils (called “pouches”) enclosed around the battery cell and heat-sealed at the connector tabs. These packagings are relatively flexible and the positive and negative connections of the battery are thus embedded in the heat-sealed polymer that was used to seal the packaging around the battery. However, this weld between the polymer foils is not totally impervious to atmospheric gases, since the polymers used to heat-seal the battery are relatively permeable to atmospheric gases. Permeability is seen to increase with the temperature, which accelerates ageing.

The surface area of these welds exposed to the atmosphere, however, remains very small, and the rest of the packaging is formed by aluminium foils sandwiched between these polymer foils. In general, two aluminium foils are combined to minimise the effects of the presence of holes, which constitute defects in each of these aluminium foils. The probability of two defects on each of the strips being aligned is greatly reduced.

These packaging technologies guarantee a calendar life of about 10 to 15 years for a 10 Ah battery with a 10×20 cm2 surface area, under normal conditions of use. If the battery is exposed to a high temperature, this life can be reduced to less than 5 years, which is insufficient for many applications. Similar technologies can be used for other electronic components, such as capacitors and active components.

As a result, there is a need for systems and methods for encapsulating thin-film batteries and other electronic components that protect the component from air, moisture and the effects of temperature. There is in particular a need for systems and methods for encapsulating thin-film lithium-ion batteries to protect them from air and water in the gas phase as well as from deterioration when the battery is subjected to charge and discharge cycles. The encapsulation system must be impervious and hermetically-sealed, it must completely enclose and cover the component or the battery, must be flexible enough to accommodate slight changes in the dimensions of the battery cell (“breaths”), and it must also allow the edges of electrodes of opposite polarities to be galvanically separated in order to prevent any creeping short-circuit.

### SUMMARY

One purpose of the present invention is to overcome, at least in part, the aforementioned drawbacks of the prior art.

The present invention aims to overcome, at least in part, some of the aforementioned drawbacks of the prior art.

It aims in particular to increase the production output for rechargeable batteries with a high energy density and a high power density and to produce more efficient encapsulations at a lower cost.

It further aims to propose an electrochemical device, of the battery type, which can easily be associated with an energy-consuming device, while offering particularly satisfactory protection against gases such as O₂ and H₂O.

It aims in particular to propose a method that reduces the risk of a short-circuit, and that allows a battery with a low self-discharge rate to be manufactured.

It aims in particular to propose a method that allows a battery with a very long life to be manufactured in a simple, reliable and fast manner.

It further aims to propose such a method, which uses a higher-quality cutting step than that used in the prior art.

It further aims to propose such a method, which enhances the encapsulation phases and the encapsulation itself, which takes place during the production of the final battery.

It further aims to propose a method for manufacturing batteries that generates a smaller loss of material.

At least one of the above purposes is achieved by an electrochemical device, of the battery type, by the manufacturing method thereof, and by an electric energy-consuming device comprising this electrochemical device, according to the accompanying claims.

A first object of the invention is an electrochemical device of the battery type comprising:

a so-called unit stack (2) formed by at least one unit cell, each unit cell successively comprising at least one anode current-collecting substrate, at least one anode layer, at least one layer of an electrolyte material or of a separator impregnated with an electrolyte, at least one cathode layer, and at least one cathode current-collecting substrate, said unit stack defining six faces, i.e. two so-called frontal faces (21 and 22) opposite one another, generally parallel to the anode, electrolyte material and cathode layers, as well as four so-called lateral faces (23 to 26) opposite one another in pairs, in particular parallel to one another in pairs;

anode contact means (30);

cathode contact means (40); and

sealing means (7), which are capable of protecting said stack.

The electrochemical device further comprises:

an electrical connection support (5), made at least in part of a conductive material, provided near a first frontal face (12) of said unit stack; and

electrical insulation means (53, 54), enabling two distant regions (56, 57) of said electrical connection support (5) to be insulated from one another,

wherein the anode contact means (30) allow a first lateral face (23) of said unit stack to be electrically connected to the electrical connection support (5), and the cathode contact means (40) allow a second lateral face (24) of said unit stack, opposite said first lateral face, to be electrically connected to said electrical connection support (5).

According to other features of the electrochemical device, which may be taken in isolation or according to any technically compatible feature:

the impervious sealing means comprise an encapsulation system (7),

said encapsulation system (7) covers the other frontal face (11) of said unit stack, the anode contact means, the cathode contact means, and at least in part the face (51) of said electrical connection support (5) that is facing said unit stack,

said encapsulation system covers the opposite frontal faces of said unit stack, as well as the lateral faces of said stack which are not covered by the anode and cathode contact means,

said encapsulation system further occupying, optionally, all or part of the electrical insulation means (53, 54), as well as the intermediate space separating the support from said first frontal face of the unit stack,

the impervious sealing means comprise said anode contact means and/or said cathode contact means, and

the sealing means comprise, on the one hand, the contact means covering two first lateral faces of the stack and, on the other hand, the encapsulation system covering the other two lateral faces of the stack as well as the two frontal faces of the stack.

The electrochemical device further comprises a mechanical stiffening system (8), covering the encapsulation system opposite the electrical connection support (5),

wherein the electrical connection support is of the single-layer type, in particular a metal grid or a silicon interlayer,

wherein the electrical insulation means comprise one or more free spaces made in said electrical connection support of the single-layer type, these free spaces being capable of being empty or filled with an electrically-insulating material, the distant connection regions of said electrical connection support being placed on either side of these free spaces,

wherein the electrical connection support comprises a single free space, on either side whereof the distant connection regions are provided,

wherein the support comprises two free spaces, between which a central base plate of said electrical connection support is provided,

wherein the electrical connection support is of the multilayer type and comprises a plurality of layers disposed one below the other, this support being in particular of the printed circuit board type, and

wherein each layer of the multi-layer support comprises at least one conductive zone and at least one insulating zone, the conductive zones of the different layers forming electrical connection paths capable of connecting the anode and cathode contact means respectively to the face of the support, which is opposite the stack, whereas said insulating zones form said electrical insulation means.

The encapsulation system is selected from among:

a dense inorganic film deposited by a technique selected from among ALD, PECVD or HDPCVD, with a total thickness of less than 5 μm and preferably less than 2 μm, or

a succession of inorganic films with a total thickness of less than 5 μm, preferably less than 2 μm, or

a succession of organic and inorganic films with a total thickness of less than 20 μm, preferably less than 10 μm.

The mechanical stiffening system is selected from among:

a resin, which can consist of a simple polymer or a polymer having a polymer matrix, which is preferably an epoxy or acrylate polymer, and a mineral filler, which can consist of particles, flakes or glass fibres;

a low melting point glass, preferably chosen from the group formed by: SiO₂—B₂O₃ glasses; Bi₂O₃—B₂O₃ glasses, ZnO—Bi₂O₃—B₂O₃ glasses, TeO₂—V₂O₅ glasses, and PbO—SiO₂, glasses; or

a film produced by rolling.

The electrochemical device further comprises rigid connection means (6), enabling one (21) of the frontal faces of the unit stack to be rigidly connected to said electrical connection support (5), the rigid connection means comprising a layer of a non-conductive adhesive (6),

wherein the anode or cathode electrical contact means comprise a conductive adhesive, and

wherein the anode or cathode electrical contact means comprise a metal foil.

The invention also relates to a method of manufacturing a battery-type of electrochemical device, said method comprising:

placing the electrical connection support (5) near the first frontal face (12) of said unit stack;

insulating the two distant regions (56, 57) of said electrical connection support (5) from one another;

electrically connecting the first lateral face (23) of said unit stack to the electrical connection support (5);

electrically connecting the second lateral face (24) of said unit stack, opposite said first lateral face, to said electrical connection support (5); and

coating the impervious sealing means.

According to other features of the electrochemical device, which may be taken in isolation or according to any technically compatible feature:

the impervious sealing means are coated after the electrical connection support has been placed near the first frontal face of the unit stack,

at least part of the impervious sealing means is coated before the electrical connection support is placed near the first frontal face of the unit stack, and

at least one first layer of the impervious sealing means is coated before the electrical connection support is placed near the first frontal face of the unit stack, then at least one second layer of the impervious sealing means is coated after said electrical connection support has been placed near said first frontal face.

The method further comprises:

supplying a frame (105) intended to form a plurality of supports (5);

placing said frame near the first frontal face of a plurality of unit stacks, these stacks being arranged in a plurality of lines and/or a plurality of rows; and

making at least one cut, in particular a plurality of cuts in the longitudinal direction and/or lateral direction of these stacks, so as to form a plurality of electrochemical devices.

Finally, the invention has for object an electric energy-consuming device (1000) comprising a body (1002) and an electrochemical device (1) as above, said electrochemical device being capable of supplying electric energy to said electric energy-consuming device, and said electrical connection support (5) of said electrochemical device being fastened to said body.

### DRAWINGS

The invention will be described hereinbelow with reference to the accompanying drawings, provided in the form of non-limiting examples only, in which:

FIG. 1 is a longitudinal, sectional view showing a battery forming an electrochemical device according to a first embodiment of the invention.

FIG. 2 is an overhead view showing a frame used to manufacture the battery according to the invention shown in FIG. 1.

FIG. 3 is an overhead view showing a first step in a method for manufacturing the battery according to the invention.

FIG. 4 is an overhead view showing a second step in a method for manufacturing the battery according to the invention.

FIG. 5 is an overhead view showing a third step in a method for manufacturing the battery according to the invention.

FIG. 6 is an overhead view showing a fourth step in a method for manufacturing the battery according to the invention.

FIG. 7 is an overhead view showing a fifth step in a method for manufacturing the battery according to the invention.

FIG. 8 is an overhead view showing a sixth step in a method for manufacturing the battery according to the invention.

FIG. 9 is a longitudinal, sectional view showing the different component elements of the battery, installed at the end of the first step hereinabove.

FIG. 10 is a longitudinal, sectional view showing the different component elements of the battery, installed at the end of the second step hereinabove.

FIG. 11 is a longitudinal, sectional view showing the different component elements of the battery, installed at the end of the third step hereinabove.

FIG. 12 is a longitudinal, sectional view showing the different component elements of the battery, installed at the end of the fourth step hereinabove.

FIG. 13 is a longitudinal, sectional view showing the different component elements of the battery, installed at the end of the fifth step hereinabove.

FIG. 14 is an overhead view, similar to that in FIG. 2, showing a support frame for manufacturing a battery forming an alternative embodiment to the first embodiment of the invention.

FIG. 15 is a longitudinal sectional view showing a battery according to the invention, which can be obtained from the frame shown in FIG. 14.

FIG. 16 is an overhead view similar to that in FIG. 2, showing a support frame for manufacturing an electrochemical device according to another alternative embodiment to the first embodiment of the invention.

FIG. 17 is a longitudinal, sectional view showing an electrochemical device according to the invention, which can be obtained from the frame shown in FIG. 16.

FIG. 18 is a diagrammatic view showing the integration of an electrochemical device according to the invention into an energy-consuming device.

FIG. 19 is a longitudinal, sectional view showing an alternative way of carrying out the step of the method described in FIG. 10.

FIG. 20 is a longitudinal, sectional view showing an alternative way of carrying out the step of the method described in FIG. 11.

FIG. 21 is a longitudinal sectional view similar to that in FIG. 20, showing an additional step of the method for producing an electrochemical device of the invention.

FIG. 22 is a front view, similar to that in FIG. 1, showing, on a larger scale, an alternative embodiment of the encapsulation system according to the invention.

FIG. 23 is a perspective view showing stacked strata used in the simultaneous production of a plurality of electrochemical devices according to the invention.

FIG. 24 is a perspective view showing an alternative embodiment of the stacked strata shown in FIG. 23.

FIG. 25 is a sectional view showing a conductive support according to a second embodiment of the invention in its simplest structure.

FIG. 26 is a perspective view showing the different component elements of a conductive support, of an enriched structure, belonging to an electrochemical device according to an alternative embodiment to the second embodiment shown in FIG. 25.

FIG. 27 is a sectional view showing an energy-consuming device incorporating an electrochemical device provided with the conductive support shown in FIG. 26.

FIG. 28 is a perspective view showing another alternative embodiment of the conductive support according to the second embodiment.

FIG. 29 is a perspective view similar to that in FIG. 28, showing yet another alternative embodiment of the conductive support according to the second embodiment.

### DESCRIPTION

As will be seen from the description hereinbelow, the electrochemical device according to the invention essentially comprises a unit stack, an electrical connection support, anode and respectively cathode contact means, and impervious sealing means intended to protect in particular the aforementioned stack. This description refers to two main embodiments of the invention, as regards the structure of the aforementioned support, as well as to different alternative embodiments to these main embodiments.

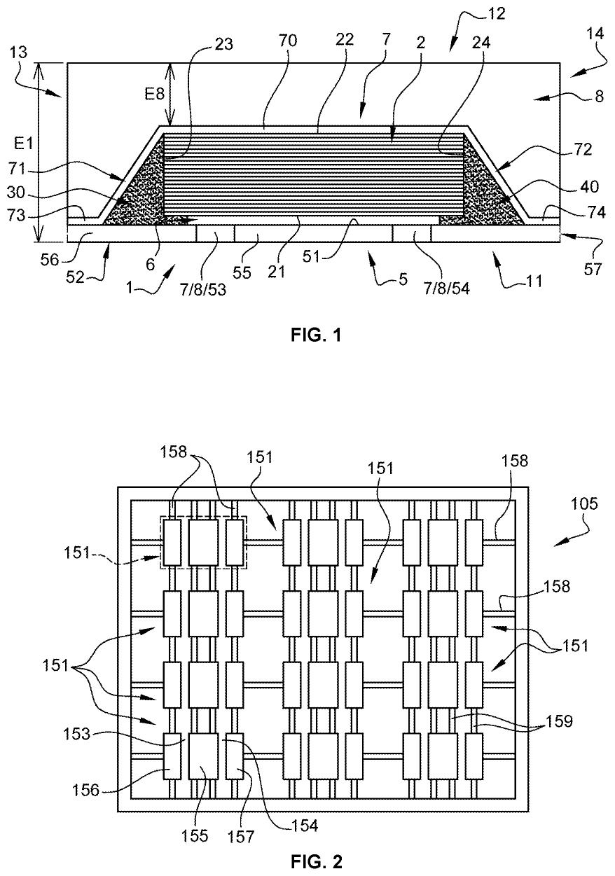

FIG. 1 shows an electrochemical device according to a first alternative embodiment to the first main embodiment of the invention, which is a battery denoted as a whole by the reference numeral 1. This battery firstly comprises a stack 2 formed by at least one and, typically, by a plurality of unit cells. Each of these unit cells successively comprises at least one anode current-collecting substrate, at least one anode layer, at least one layer of an electrolyte material or of a separator impregnated with an electrolyte, at least one cathode layer, and at least one cathode current-collecting substrate.

This stack is of a type known per se and will thus not be described in more detail hereinbelow. Typically, this stack comprises between 10 and 100 unit cells, as described hereinabove. This stack 2, which is parallelepipedal overall, has six faces. The opposing so-called frontal or end faces which, by convention, are substantially parallel to the different layers above, are firstly denoted by the reference numerals 21 and 22. The so-called front frontal face is denoted by the reference numeral 21 and the so-called rear frontal face which, as will be seen hereinbelow, allows a support to be fastened, is denoted by the reference numeral 22. The stack 2 also defines four lateral faces 23 to 26, which are parallel and opposite one another in pairs.

The battery 1 according to the invention further comprises a support, referred to as a whole by the reference numeral 5. This support 5, which is generally planar, typically has a thickness of less than 300 μm, preferably less than 100 μm. This support is advantageously made of an electrically conductive material, typically a metal material, in particular aluminium, copper, or stainless steel, which can be coated to improve the weldability property thereof by a thin layer of gold, nickel and tin. The front face of the support is respectively given the reference numeral 51 and faces the stack 2, and the opposite, rear face is given the reference numeral 52.

This support is perforated, i.e., it has spaces 53 and 54 delimiting a central base plate 55 and two opposite lateral strips 56 and 57. The different regions 55, 56 and 57 of this support are thus electrically insulated from one another. In particular, as will be seen hereafter, the lateral strips 56 and 57 form regions which are electrically insulated from one another and which can be connected to contact members belonging to the battery. In the example shown, electrical insulation is achieved by providing empty spaces 53 and 54 which, as will be seen hereafter, are filled with a stiffening material. Alternatively, these spaces can be filled with a non-conductive material, for example polymers, ceramics, or glasses.

In the example shown, the support and the stack are connected to one another by a layer 6. The latter is typically formed by means of a non-conductive adhesive, in particular of the epoxy or acrylate type. Alternatively, the support and the stack can be rigidly secured to one another by means of a weld, not shown. The thickness of this layer 6 is typically comprised between 5 and 100 μm, in particular, equal to about 50 μm. According to the main plane of the support 5, this layer at least partially covers the aforementioned spaces 53 and 54, so as to insulate the anode and cathode contact members from one another as described in detail hereinbelow.

The support 5 provides an additional electrical connection function, in that it is electrically connected to the stack 2 described hereinabove. In the example shown, this electrical connection is procured by means of pads 30 and 40, forming anode and cathode contact members respectively. These pads 30 and 40 are made of a suitable conductive material, in particular a conductive adhesive such as, for example, a graphite adhesive, an adhesive filled with metal nanoparticles (Au, Cu, Al, etc.). The metal fillers can be different for the anode and cathode (typically Al for the cathode, Cu for the anode). In such a case, these pads not only provide their initial electrical connection function, but also provide an additional function of creating a rigid mechanical connection between the stack and the support.

Alternatively, these pads 30 and 40 can also be made of a material that is different from a conductive adhesive, such as a weld. In the example shown, these pads have been diagrammatically illustrated in a triangular shape, the thickness whereof increasing in the direction of the support. Nonetheless, alternatively, these pads can have a different shape, in particular a constant thickness.

The battery according to the invention further comprises an encapsulation system, referred to as a whole by the reference numeral 7. This encapsulation system 7 firstly includes a central zone 70, covering the front frontal face of the stack. This central zone is advantageously extended on both sides by intermediate regions, or flanges 71 and 72, covering the electrical connection pads 30 and 40. Finally, these intermediate regions are themselves extended, again advantageously, by ends or lips 73 and 74 covering part of the front frontal face of the support 5.

FIG. 1 shows, as seen hereinabove, a longitudinal section of the battery. From a cross-sectional view, which is not shown, the encapsulation system covers the lateral faces 15 and 16 of the stack, which are not equipped with the contact members 20, 30. This encapsulation system further covers at least part of the front frontal face of the support, according to this cross-sectional view.

This encapsulation system 7 can be made of any material that provides an impervious sealing function. For the purposes of the invention, this function is provided by any encapsulation system that preferably has a water vapour permeance (“WVTR”) of less than 10⁻⁵ g/m²·d. The following can be deposited for example:
a dense inorganic film by ALD, PECVD HDPCVD less than 5 μm and preferably less than 2 μm thick. The inorganic film can be made of SiO₂, Si₃N₄, SiC, amorphous Si, or Al₂O₃,
a succession of inorganic films with a total thickness of less than 5 μm and preferably less than 2 μm. The inorganic films can be made of SiO₂, Si₃N₄, SiC, amorphous Si, or Al₂O₃ deposited by any dry or wet technique (PECVD, PVD, ALD, Spray coating+UV conversion, sol-gel, etc.), and
a succession of organic and inorganic films less than 20 μm and preferably less than 10 μm thick. The inorganic films can be made of SiO₂, Si₃N₄, SiC, or amorphous Si, deposited by a dry or wet technique (PECVD, PVD, ALD, Spray coating+UV conversion, sol-gel, etc.), The organic films can be a polymer (PVDF, Parylene, Acrylates, etc.).

Finally, the battery according to the invention is further equipped with a stiffening system, referred to as a whole by the reference numeral 8. This stiffening system covers the entire encapsulation system 7, opposite the support 5. In addition, it covers at least part and, advantageously, as in the example shown, the entire front face of the support 5.

In order to guarantee the essential imperviousness criterion, it must be ensured that the components that are potentially detrimental to the correct operation of the battery, cannot access the unit stack of the anodes and cathodes. In other words, according to the invention, this involves preventing any potential “gateway” for the detrimental components thereof. For this purpose, the encapsulation material 7 also occupies, advantageously, the free spaces 53, 54 in the support 5. It should be noted that the stiffening material 8 also advantageously fills these free spaces, by being intimately linked to the encapsulation material. In FIG. 1, the reference numerals 7 and 8, as well as 53 and 54, have been placed in the same zones corresponding to these free spaces, in order to visualise the filling thereof with these various materials.

This stiffening system 8 can be made of any material that provides this mechanical stiffness function. With this in mind, a resin can be chosen for example, which can consist of a simple polymer or a polymer filled with inorganic fillers. The polymer matrix can be from the family of epoxies, acrylates or fluorinated polymers for example, and the fillers can be formed by particles, flakes or glass fibres. Advantageously, this stiffening system 8 can provide an additional moisture barrier function. With this in mind, a low melting point glass can be chosen, for example, thus ensuring the mechanical strength and providing an additional moisture barrier. This glass can be, for example, from the SiO₂—B₂O₃; Bi₂O₃—B₂O₃, ZnO—Bi₂O₃—B₂O₃, TeO₂—V₂O₅ or PbO—SiO₂ family.

As shown hereinabove, the thickness of the encapsulation system 7 is advantageously very low, in particular less than 20 μm, preferably equal to 10 μm. Typically, the stiffening system 8 is much thicker than the encapsulation system 7. With reference to FIG. 1 the smallest thickness of this stiffening system, at the covering of the front face of the stack, is denoted by the reference E8. Advantageously, this thickness E8 is comprised between 20 and 250 μm, typically equal to about 100 μm.

The battery 1 according to the invention, as shown in FIG. 1, is generally parallelepiped in shape. By analogy with the stack 2, the front and rear frontal faces thereof are denoted by the reference numerals 11 and 12, and the different lateral faces thereof are denoted by the reference numerals 13 to 16. By way of non-limiting examples, the thickness E1 of the battery is, for example, comprised between 0.5 and 2.5 mm, whereas the transverse dimensions L1 and I1 thereof are, for example, comprised between 1 and 4 mm.

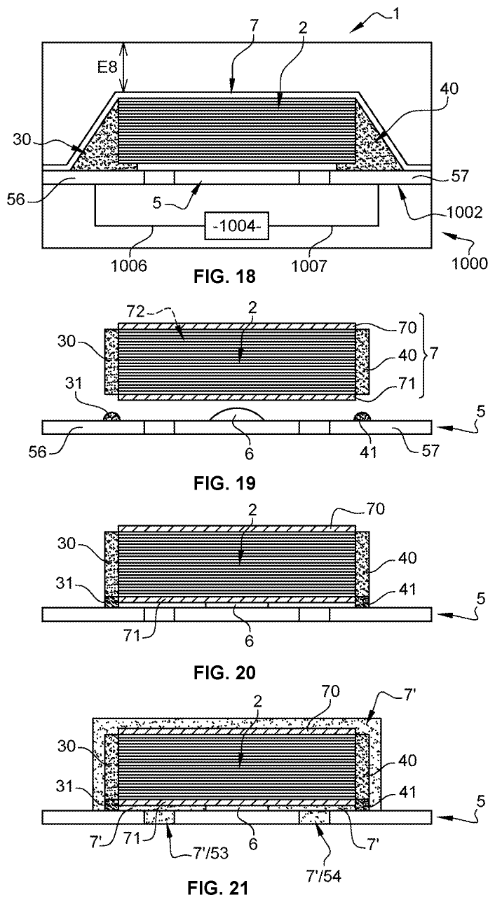

In operation, in a conventional manner, electrical energy is generated by electrochemical conversion at the unit stack. This energy is transmitted to the conductive regions 55 and 56 of the support 50, via the contact members. Since these conductive regions are insulated from one another, there is no risk of a short-circuit. This electrical energy is then directed from the regions 56 and 57 to an energy-consuming device of any appropriate type. In FIG. 18, this energy-consuming device is represented diagrammatically and is denoted by the reference numeral 1000. It comprises a body 1002, on which the lower face of the support rests. The mutual fastening between this body 1002 and the support 5 is achieved by any appropriate means.

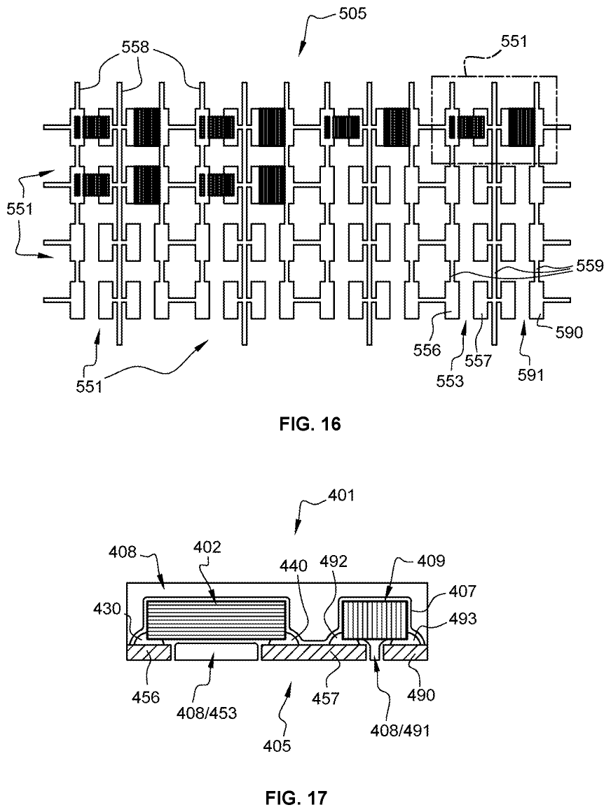

The device 1000 further comprises an energy-consuming element 1004, as well as connection lines 1006, 1007 electrically connecting the regions 56, 57 of the support 5 to this element 1004. Control thereof can be provided by a component of the battery itself, according to the embodiment described hereinbelow with reference to FIG. 16, and/or by a component, not shown, belonging to the device 1000. By way of non-limiting examples, such an energy-consuming device can be an electronic circuit of the amplifier type, an electronic circuit of the clock type (such as a real time clock (RTC) component), an electronic circuit of the volatile memory type, an electronic circuit of the static random access memory (SRAM) type, an electronic circuit of the microprocessor type, an electronic circuit of the watchdog timer type, a component of the liquid crystal display type, a component of the LED (light emitting diode) type, an electronic circuit of the voltage regulator type (such as a low-dropout regulator circuit (LDO)), or an electronic component of the CPU (central processing unit) type.

The different steps of a method for manufacturing the battery 1 described hereinabove in FIG. 6 will now be described with reference to FIGS. 2 to 13. In order to implement this method, a support frame 104 is advantageously used, and which is intended to form a plurality of supports 4. This frame 104, which is shown at a large scale in FIG. 2, has a peripheral border 150, as well as a plurality of preforms 151, each of which allows one respective battery to be manufactured. In the example shown, twelve mutually identical preforms can be seen, divided into three lines and four columns. Alternatively, a frame with a different number of such preforms can be used.

Each preform comprises a central area 155, intended to form the base plate 55, and two lateral blocks 156 and 157 intended to form the strips 56 and 57 respectively. The area and the blocks are separated from one another by grooves 153 and 154, which are intended to form the spaces 53 and 54. The different preforms are fixed, both in relation to one another and to the peripheral edge by means of different horizontal rods 158 and vertical rods 159 respectively.

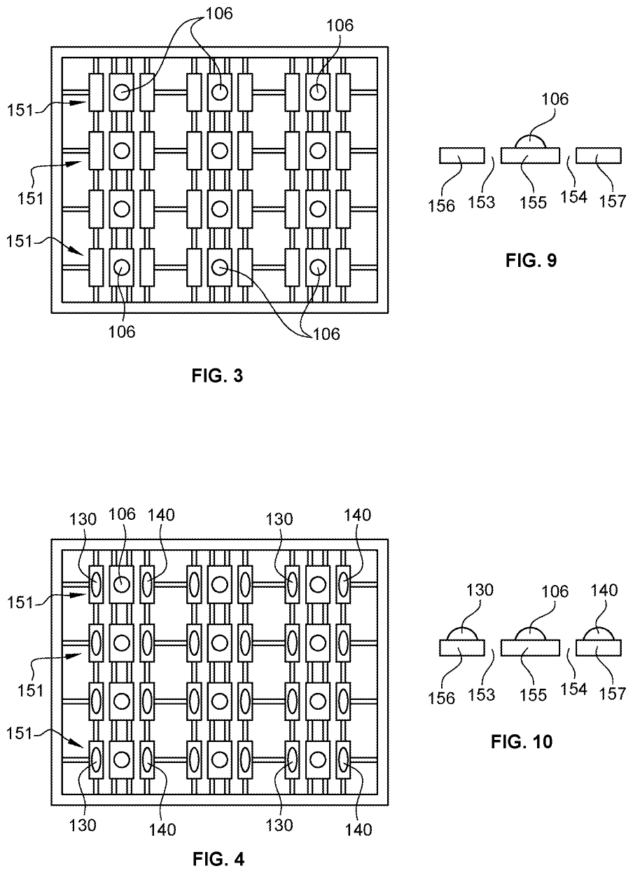

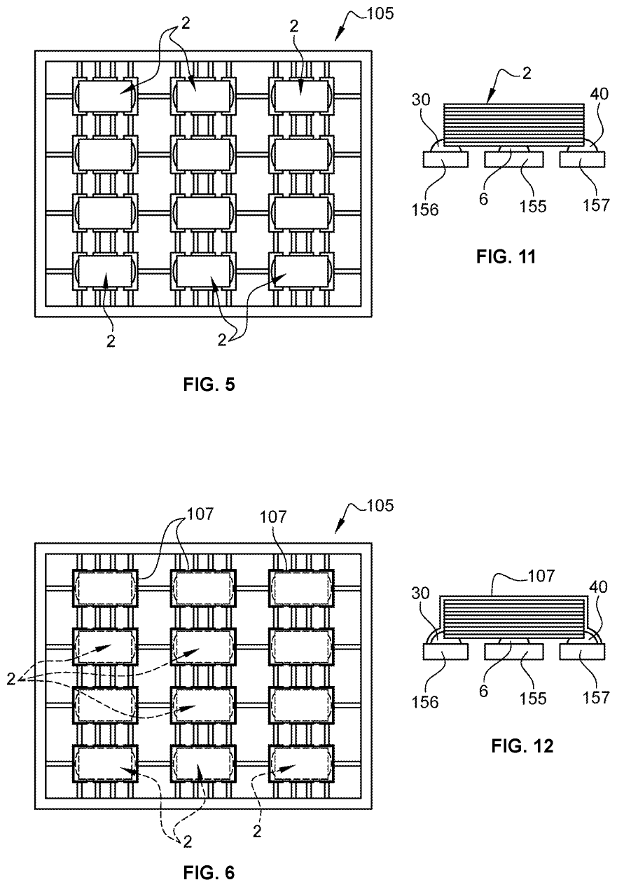

In a first step, which is shown in FIGS. 3 and 9, a dose 106 of non-conductive adhesive is deposited on each area 155 intended to form the layer 6. Then, a respective dose 130 and 140 of conductive adhesive intended to form the pads 30 and 40 is deposited on each lateral block 156, 157. This second step is shown in FIGS. 4 and 10. In a third step, shown in FIGS. 5 and 11, the different stacks 2 are disposed on the different doses 106, 130 and 140. These stacks are placed, in relation to the areas 145 and to the blocks 146, 147, in the precise position they must adopt in relation to the base plate 45 and the final strips 46, 47.

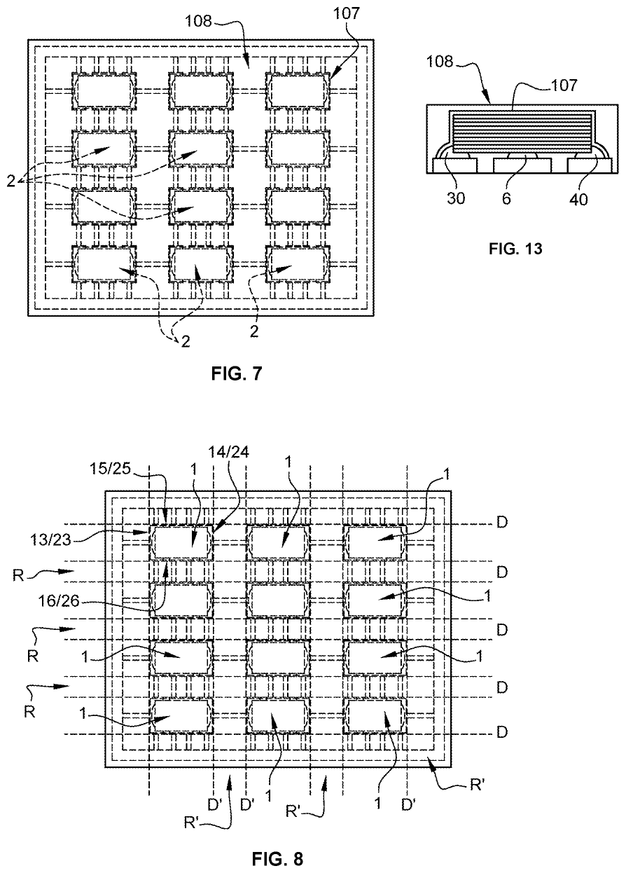

In a fourth step, shown in FIGS. 6 and 12, a material 107 is deposited to form the different encapsulation systems 7. Then, in the fifth step shown in FIGS. 7 and 13, a material 108 is deposited to form the different stiffening systems 8. Finally, as shown in FIG. 8, a cut is made in the frame 140, on which the different components of the plurality of batteries have been disposed. The different cutting lines are marked with dotted lines and given, on the one hand, the reference D for cuts in the longitudinal dimension of the batteries, and on the other hand, the reference D′ for cuts in the lateral dimension thereof. It should be noted that, in the two dimensions of the frame, certain zones R and R′ are intended to be discarded.

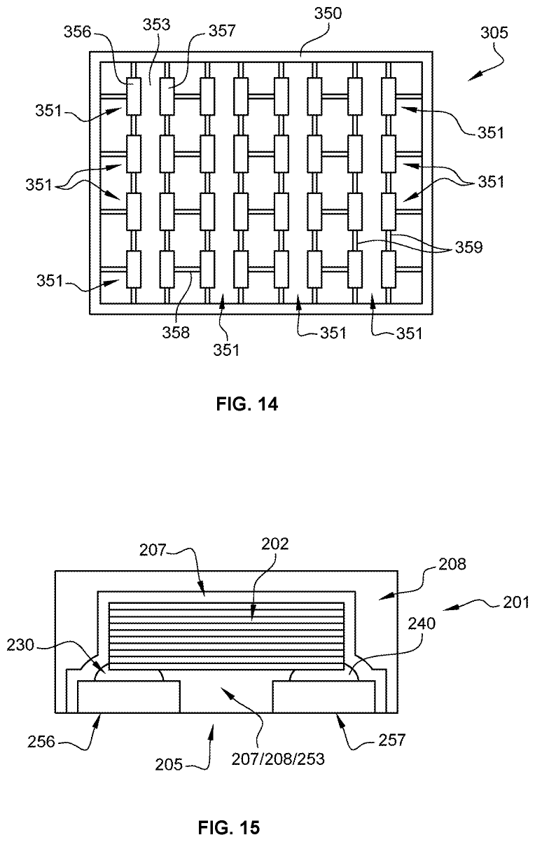

FIGS. 14 and 15 show an alternative embodiment to the first embodiment of the invention, which has been described hereinabove. In FIGS. 14 and 15, the mechanical elements that are similar to those shown in FIGS. 1 to 13, are given the same reference numerals incremented by 200. The battery 201, visible in FIG. 15, differs from the battery 1 in the preceding figures, in particular due to the structure of the connection support 205 thereof. More precisely, this support 205 does not have a central base plate, such as that 55 in the preceding figures. Thus, this support includes two lateral strips 256 and 257, which are separated by a space 253 ensuring the insulation thereof from one another.

As a result, this battery 201 is also devoid of the non-conductive adhesive layer 6. Under these conditions, the encapsulation system 207 advantageously also covers the rear face of the stack 202. Moreover, the stiffening system also occupies all or part of this rear face. As mentioned hereinabove, the encapsulation material and the stiffening material are liable to be intimately mixed, partially in the aforementioned space 253.

The support frame 305, allowing for the creation of a plurality of batteries, similar to those in FIG. 15, can be seen in FIG. 14. This frame 305 differs from the frame 105 in that the preforms 351 that it contains do not have a central area. The blocks allowing for the final formation of the lateral strips 256 and 257 have been denoted by the reference numerals 356 and 357, and the groove separating these blocks 356 and 357 has been denoted by the reference numeral 353. The method for manufacturing the battery 201 is broadly similar to that described hereinabove with reference to the battery 1. The main difference lies in the fact that this method does not include a step of depositing a dose of non-conductive adhesive.

The presence of the encapsulation system, which covers both the stack, the contact members and part of the support, gives the battery a satisfactory imperviousness. Moreover, the presence of an additional stiffening system brings additional advantages. This stiffening system thus provides a mechanical and chemical protection function, optionally combined with an additional gas barrier function.

FIGS. 16 and 17 show an additional alternative embodiment of an electrochemical device according to the first embodiment of the invention. In FIGS. 16 and 17, the mechanical elements that are similar to those shown in FIGS. 1 to 13, are given the same reference numerals incremented by 400. The electrochemical device 401, visible in FIG. 17, differs from the batteries 1 and 201 hereinabove, particularly in that it includes an additional electronic component. The latter, which is denoted by the reference numeral 409, is of any appropriate type. For example, it can be a component of the LDO (“low dropout regulator”) type. In a manner known per se, the function of this component is to regulate the potential of the battery.

According to an alternative embodiment, not shown, the electrochemical device according to the invention can include a plurality of additional electronic components. Typically, production of a mini-circuit with a complex electronic function can be envisaged. With this in mind, an RTC (“real time clock”) module or an energy harvesting module can be used. An electronic component capable of controlling the battery shown in FIG. 18 hereinabove, and which has an integrated energy-consuming device, can also be provided.

Structurally, the stack 402 rests, via the conductive adhesive layers 430 and 440, on a lateral strip 456 and a base plate 457 of the support. This strip is electrically separated from this base plate by a space 453. Moreover, the LDO component rests, via additional layers of conductive adhesive 492, 493, on the one hand on the aforementioned area 457 and on a lateral strip 490 of the support. This area and this strip 490 are insulated from one another by a space 491.

The support frame 505, allowing for the production of a plurality of electrochemical devices similar to the electrochemical device 401 in FIG. 17, is shown in FIG. 16. This frame 505 is broadly similar to the frame 105, in particular in that it has a central base plate 557, and two blocks 556 and 590. The method for manufacturing the electrochemical device 401 is broadly similar to that described hereinabove with reference to manufacture of the battery 1. The main differences lie, first of all, in the fact that the manufacture of the electrochemical device 400 does not involve the deposition of doses of a non-conductive adhesive. Moreover, this manufacture of the device 401 involves the deposition of a plurality of doses of conductive adhesive, which are intended to form the different layers 430, 440, 492, 493.

According to an alternative embodiment not shown, the battery according to the invention can be provided such that it is devoid of any stiffening system, such as that given the reference numeral 8. This alternative embodiment can be applied in particular in the case of the encapsulation system 7 having a high mechanical strength. Such a battery, devoid of any stiffening system, can be delivered as is to the end user. The latter can thus choose either to use the battery as is, or to then cover this battery with a stiffening system if the need arises.

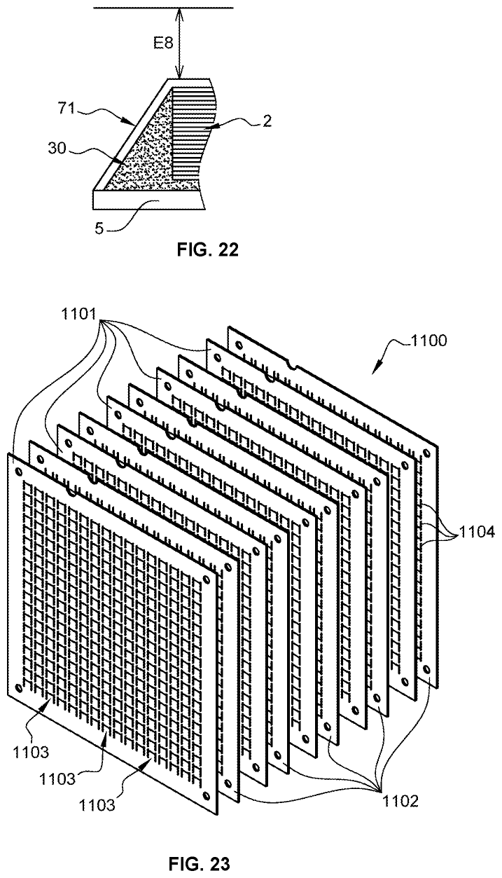

According to an additional alternative embodiment, shown in FIG. 22, the encapsulation system 7 can be provided such that it has smaller dimensions than those shown in FIG. 1. In such a case, the flanges 71 come directly into contact with the opposite surfaces of the support 5, so as to ensure this impervious sealing function.

In the method described hereinabove, a non-encapsulated stack 2 is disposed on the conductive support 5, then this stack is successively coated with the encapsulation system and then with the stiffening system. Alternatively, a stack that has already been encapsulated can be disposed on the support: it is thus possible either to leave this encapsulated stack as is or to “re-encapsulate” said stack.

With reference to FIG. 19, a stack 2 that has already been encapsulated, i.e. covered with an encapsulation 7 consisting of a top layer 70 and a bottom layer 71, has been diagrammatically shown. This encapsulation further comprises non-visible lateral layers, situated respectively on the front and the rear of the foil (for the latter layer, refer to the dotted-line reference 72). Moreover, the other two faces of the stack are covered by means of contact members 30, 40.

Firstly, it is assumed that the material making up the contact members 30 and 40 with which the encapsulated stack of FIG. 19 is equipped, is capable of providing an impervious sealing function according to the above criterion. Such a material is, for example, a conductive glass, possibly filled with a metal powder; for example, a product marketed by Koartan under the name 4101 Viafill Gold Conductor Paste can be used.

In such a case, as shown in FIGS. 19 and 20, the assembly formed by the stack 2, the encapsulation 7 and the contact members 30 and 40 can be placed on the support 5 without any additional encapsulation. It should be noted in this respect that this assembly 2, 7, 30, 40 is perfectly impervious, thanks to the nature of the encapsulation and of the contact members. In this manner, the stack 2 is protected from the penetration of potentially detrimental gases.

FIGS. 19 and 20 show conductive adhesive pads 31 and 41, which are used to fasten the contact members to the support while ensuring electrical continuity. A layer 6 of non-conductive adhesive has also been shown, which is sandwiched between the aforementioned pads 31, 41. It should be noted that FIG. 19 shows the same step in the method as FIGS. 4 and 10, whereas FIG. 20 shows the same step in the method as FIGS. 5 and 11. One possibility that is not shown provides for subsequently depositing a peripheral stiffening system, similar to that shown in FIG. 8.

It is now assumed that the above assembly 2, 7, 30, 40 is not impervious. This typically occurs when the contact members 30 and 40 are made of a material that is not impervious, as understood within the scope of the invention. In such a case, the same steps as those described hereinabove with reference to FIGS. 19 and 20 are repeated. Then, as shown in FIG. 21, a so-called additional encapsulation layer 7′ is deposited.

As shown in the description of the first embodiment, the invention guarantees perfect imperviousness. In the event that this imperviousness cannot be provided by the contact members 30 and 40 in FIG. 21, this layer 7′ must occupy all zones that could form gateways for the detrimental components. To this end, this layer will firstly be located on the top and lateral perimeter of the battery. Moreover, this additional encapsulation material also occupies the intermediate space between the encapsulation layer 71 and the support 5, as well as the free spaces 52 and 53.

This occupation has been shown several times in FIG. 21 using the reference numeral 7′. Once the encapsulation has been produced, the battery can be covered by means of a stiffening system, not shown in FIG. 21. In such a case, as described in particular with reference to FIG. 15, these stiffening and encapsulating materials are capable of being intimately mixed.

Advantageously, as is known per se, a plurality of unit stacks, such as that described hereinabove, can be produced simultaneously. This increases the efficiency of the overall method for manufacturing the batteries according to the invention. In particular, a stack having large dimensions can be produced, formed by an alternating succession of cathode and respectively anode strata, or foils.

The physical-chemical structure of each anode or cathode foil, which is of a type known, for example, in the French Patent Publication No. FR 3 091 036 filed by the Applicant, does not fall within the scope of the invention and will be described only briefly. Each anode or respectively cathode foil comprises an anode active layer or respectively a cathode active layer. Each of these active layers can be solid, i.e., they can have a dense or porous nature. Furthermore, in order to prevent electrical contact between two adjacent foils, a layer of electrolyte or a separator impregnated with a liquid electrolyte is disposed on at least one of these two foils, in contact with the opposite foil. The electrolyte layer or the separator impregnated with a liquid electrolyte, not shown in the figures describing the present invention, is sandwiched between two foils of opposite polarity, i.e., between the anode foil and the cathode foil.

These strata are indented so as to define so-called empty zones which will allow for the separation between the different final batteries. Within the scope of the present invention, different shapes can be assigned to these empty zones. As already proposed by the Applicant in the French Patent Publication No. FR 3 091 036, these empty zones can be H-shaped. The accompanying FIG. 23 shows the stack 1100 between anode foils or strata 1101 and cathode foils or strata 1102. As shown in this figure, cuts are made in these different foils to create said H-shaped anode 1103 and respectively cathode 1104 empty zones.

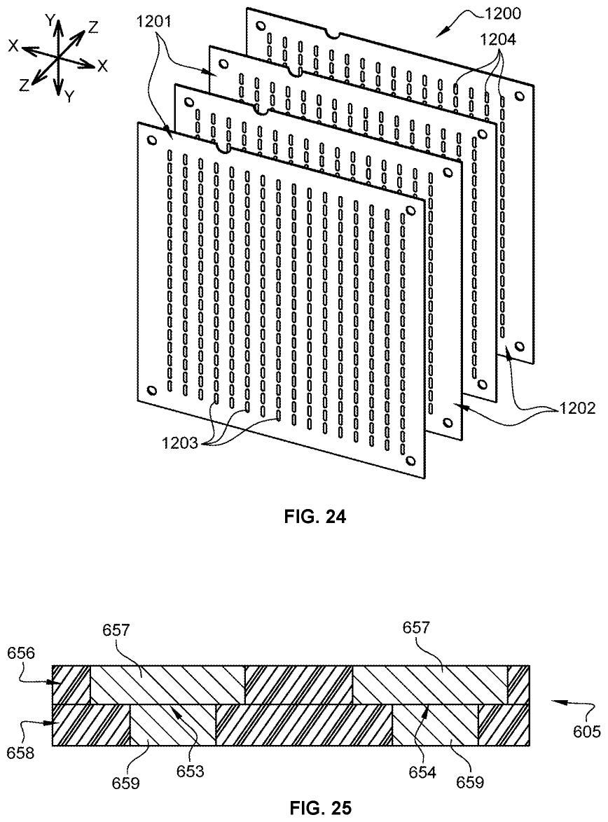

Alternatively, these free zones can also be I-shaped. The accompanying FIG. 24 shows the stack 1200 between anode foils or strata 1201 and cathode foils or strata 1202. As shown in FIG. 24, cuts are made in these different foils to create said I-shaped anode 1203 and respectively cathode 1204 empty zones.

Preferably, once the manufacture of the different unit stacks is complete, each anode and each cathode of a given battery comprises a respective primary body, separated from a respective secondary body by a space free of any electrode material, electrolyte and/or current-conducting substrate. According to an additional alternative embodiment, not shown, the empty zones can be provided such that the shapes thereof are different to a H or an I shape, such as a U shape. Nonetheless, H or I shapes are preferred.

When the unit stacks are produced simultaneously, using strata as described hereinabove, each unit stack can optionally be covered with an encapsulation layer, which itself can optionally be covered with a stiffening layer. Once the different cuts have been made, the encapsulation layer allows a plurality of encapsulation systems to be produced, whereas the stiffening layer allows a plurality of stiffening systems to be produced. The presence of a stiffening layer in particular allows the integrity of the different elements to be preserved when cutting with a saw. However, in the case of laser cutting, this stiffening layer can be superfluous.

As can be seen from the description above, the first main embodiment of the invention involves the use of a conductive support, which is a single-layer support. By way of example, this single-layer support can be of the perforated type, such as a metal grid.

Four alternative embodiments to a second main embodiment will now be described with reference to FIG. 25 onwards, in which the conductive support is a multi-layer support. This multi-layer support is of the solid type, as opposed in particular to the metal grid described hereinabove, which is of the perforated type. In FIG. 25 and onwards, the mechanical elements similar to those in FIGS. 1 to 13 are assigned the same reference numerals, respectively incremented by 600, 700, 800 and 900.

FIG. 25 firstly shows a multi-layer support 605 in its most basic structure. This support is formed by two separate layers 656 and 658, made, for example, of a polymer material. The main plane of each of these layers is substantially parallel to the plane of the different layers forming the stack. The structure of this support is thus similar to that of a printed circuit board (PCB).

Each layer 656, 658 integrates at least one metal insert, i.e. the top layer 656 integrates two separate inserts 657, whereas the bottom layer 658 integrates two other separate inserts 659. These inserts are placed in contact with one another in pairs to form electrical connection paths 653 and 654. As shown diagrammatically in FIG. 25, each electrical connection path 653, 654 is intended to connect a respective contact member with the bottom face of the support 605, which is placed on an energy-consuming device not shown in FIG. 25.

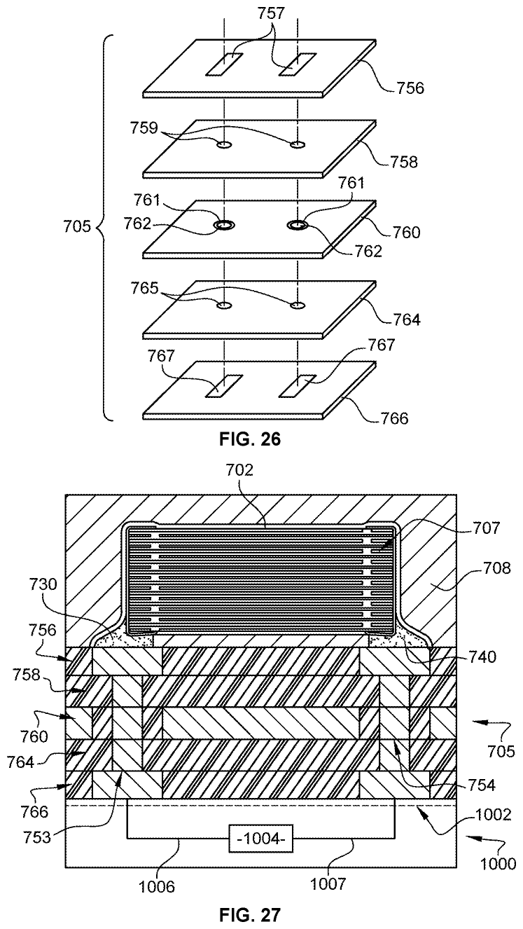

FIGS. 26 and 27 show an advantageous alternative embodiment forming a part of this second main embodiment. As shown firstly in FIG. 26, the support 705 is formed by a plurality of layers disposed one below the other, 5 whereof are shown in this example embodiment.

The figure shows, from top to bottom, a layer 756 on which the battery stack will be deposited. This layer 756, which is mainly made of a polymer material, such as epoxy resin, is provided with two inserts 757. These are made of a conductive material, in particular a metal material, and are designed to cooperate with the anode and respectively the cathode contacts of the battery. It should be noted that these inserts 757 are insulated from one another, thanks to the epoxy resin of the layer 756.

Immediately below the layer 756 is a layer 758, also made of a polymer material such as an epoxy resin. This layer 758 is provided with two inserts 759, made of a conductive material, which are brought into electrical contact with the first inserts 757. As with the layer 756, these inserts 759 are insulated from one another.

A median layer 760 is then present, which is significantly different from the layers 756 and 758 described hereinabove. More specifically, this layer 760 is made of a barrier material that can be made of glass or an inorganic layer, typically similar to that forming the inserts 757 and 759 described hereinabove. This layer is equipped with two ring-shaped inserts 761, which are made of an insulating material, in particular an epoxy resin as described hereinabove. These inserts 761 receive, in the hollow central part thereof, discs 762 made of a conductive material, which are placed in contact with the adjacent conductive inserts 759. It should be noted that these conductive discs 762 are insulated from one another via the rings 761.

Finally, bottom layers 764 and 766 in FIGS. 26 and 27 are present, which are respectively identical to the layers 758 and 756 described hereinabove. The layer 764 is equipped with two inserts 765, in contact with the discs 762, whereas the bottom layer 766 is provided with two inserts 767, in contact with the aforementioned inserts 765.

As shown more particularly in FIG. 27, the different conductive inserts 757, 759, 762, 765 and 767 define conductive paths given the reference numerals 753, 754. These conductive paths, which are insulated from one another, either by the layers 756, 758, 764 and 766 or by the discs 761, enable the opposite frontal faces of support 705 to be electrically connected. Once the support 705 has been supplied, it is placed against the bottom face of the unit stack 702, and then steps similar to those described hereinabove with reference to FIGS. 2 to 12 are carried out.

FIG. 27 shows contact pads 730, 740 and an encapsulation 707. In this second embodiment, the stiffening system can be different from that 8 of the first embodiment. A protective film 708 can in particular be deposited by means of a lamination step. Such a film, which has barrier properties, is for example made of polyethylene terephthalate (PET) incorporating inorganic multi-layers; such a suitable product is commercially available from the company 3M under the reference Ultra Barrier Film 510 or Ultra Barrier Solar Films 510-F.

FIG. 27 further shows the integration, on an energy-consuming device 1000, of the support 705, the stack 702, the conductive pads 730 and 740, the encapsulation 707 and the film 708. As with the first embodiment, the energy generated at the stack 702 is transmitted, via the contact members 730 and 740, to the upper inserts 757. This energy is then transmitted along the connection paths 753, 754 described hereinabove, to the energy-consuming device 1000.

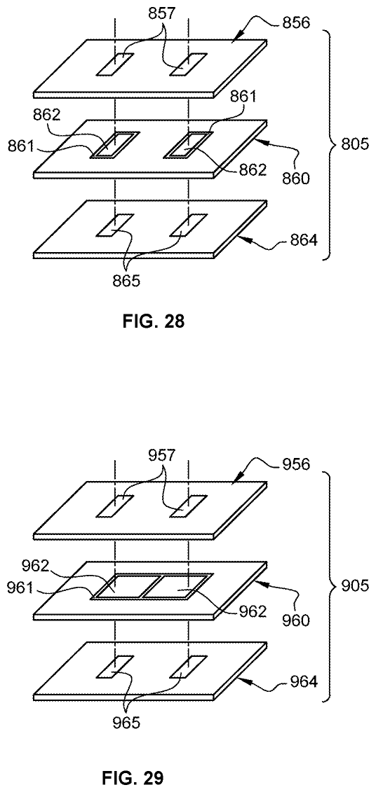

FIGS. 28 and 29 show two other alternative embodiments to this second embodiment. As in the alternative embodiment shown in FIGS. 26 and 27, the alternative embodiments in FIGS. 28 and 29 also integrate a median layer 860, 960, mostly made of a conductive material. The conductive layer 860 is equipped with two hollow inserts 861 that are rectangular in shape, and each whereof receives a central metal insert 862. By contrast, the conductive layer 960 is provided with a single hollow insert 961, which accommodates two metal inserts 962 which are insulated from one another by a bridge of material 963 of the insert 961.

However, the supports 805 and 905, shown in these FIGS. 28 and 29, differ from the aforementioned support 705 in that they are formed by three layers, not five of such layers. More specifically, they include only two predominantly insulating layers, 856, 956 and 866, 966, placed on either side of the median layer 860, 960. In these two alternative embodiments, as in the preceding alternative embodiments shown in FIGS. 25 to 27, conductive paths 853, 953 and 854, 954 are present, which connect the opposite frontal faces of the support.

The second embodiment of the invention, shown with reference to FIGS. 25 to 29, has specific advantages. More specifically, the multi-layer support such as that 605 to 905 has a very low thickness, advantageously less than 100 μm. Moreover, such a support has a certain flexibility, so that it can accommodate slight changes in the dimensions of the battery, referred to as “breaths” in the introduction to this description.

As with the first embodiment, a plurality of batteries that comply with this second embodiment, in particular battery 701 in FIGS. 26 and 27, can be produced simultaneously. For this purpose, a large multi-layer frame can be used to form a plurality of lines and a plurality of rows of supports 705. A plurality of stacks 702, of contact members 730, 740 and of encapsulation systems 707 are thus applied to this frame. A stiffening frame is also deposited, by rolling, in order to form a plurality of films 708. Finally, cuts are made, similarly to that described with reference to FIG. 14, in both the longitudinal and lateral dimensions of each individual battery.

As with the first embodiment, the stack of this second embodiment, such as the stack 702, can be placed on the conductive support thereof, such as the support 705, according to different alternative embodiments. As described hereinabove, this non-coated stack can firstly be placed on the support, and the encapsulation and optionally the stiffening film can then be applied. This stack, which has already been coated in an impervious manner, can also be placed on the support thereof without carrying out additional operations: this possibility is to be compared with that disclosed in FIGS. 19 and 20. Finally, the coated stack can be placed on the support, then subjected to additional encapsulation: this possibility is to be compared with that disclosed in FIG. 21.

According to an additional and particularly advantageous alternative embodiment, a plurality of batteries connected either in series or in parallel can be placed on the same support. These batteries are thus disposed beneath a common encapsulation system. Combining batteries in parallel is already known, however according to the prior art, the total thickness of the batteries is limited industrially by the cutting possibilities. According to the invention, the capacity of the battery can be increased by cutting two thinner batteries and connecting them to one another in the same encapsulation system. This is less expensive than producing two separate encapsulation systems.

Similarly, certain electronic circuits require higher operating voltages than the voltages delivered by a unit cell. According to the invention, two or more batteries can be connected in series under the same encapsulation system.

According to another embodiment, a microbattery and a supercapacitor and/or a capacitor connected in parallel can be combined under the same encapsulation system. Preferably, in such a combination, the operating voltage of the capacitor and/or supercapacitor is higher than the maximum voltage of the battery. With the two components mounted in parallel, the microbattery thus charges the capacitor, which can assist the battery in supplying current when the current demand is at its highest. This microbattery is preferably rechargeable.

According to another embodiment, the components mounted in parallel can be two microbatteries of different chemistry, with different voltages; these microbatteries can both be rechargeable, but it is also possible to combine a primary battery with a secondary battery, for example a high-capacity primary battery with a small, high-power secondary battery.

The battery according to the invention can be a lithium-ion microbattery, a lithium-ion mini-battery, or a high-power lithium-ion battery. In particular, it can be designed and dimensioned so as to have: a power of less than or equal to approximately 1 mA h (commonly referred to as a “microbattery”), or a power of more than approximately 1 mA h up to approximately 1 A h (commonly referred to as a “mini-battery”), or a power of more than approximately 1 A h (commonly referred to as a “high-power battery”).

Typically, microbatteries are designed to be compatible with methods for manufacturing microelectronics.

The batteries of each of these three power ranges can be produced:

with layers of the “solid-state” type, i.e. without impregnated liquid or paste phases (said liquid or paste phases can be a lithium-ion conductive medium, capable of acting as an electrolyte), or

with layers of the mesoporous “solid-state” type, impregnated with a liquid or paste phase, typically a lithium-ion conductive medium, which spontaneously penetrates the layer and no longer emerges therefrom, so that the layer can be considered to be quasi-solid, or

with impregnated porous layers (i.e. layers with a network of open pores which can be impregnated with a liquid or paste phase, which gives these layers wet properties).

1-25. (canceled)

26. An electrochemical device, comprising:
a unit stack formed by at least one unit cell, each unit cell successively including at least one anode current-collecting substrate, at least one anode layer, at least one layer of an electrolyte material or a separator impregnated with an electrolyte, at least one cathode layer, and at least one cathode current-collecting substrate, the unit stack defining six faces that includes two frontal faces opposite one another, generally parallel to the anode, electrolyte material and cathode layers, and four lateral faces opposite and parallel to one another in pairs;
an anode contact member;
a cathode contact member;
a sealing member to protect the unit stack;
an electrical connection support, made at least in part of a conductive material, provided near a first frontal face of the unit stack; and
electrical insulation members to insulate two distant regions of the electrical connection support from one another,
wherein:
the anode contact member electrically connects a first lateral face of the unit stack to the electrical connection support, and
the cathode contact member electrically connects a second lateral face of the unit stack, opposite the first lateral face, to the electrical connection support.

27. The electrochemical device of claim 26, wherein:
the sealing member comprises an encapsulation system, and
the encapsulation system covers the other frontal face of the unit stack, the anode contact member, the cathode contact member, and at least in part a face of the electrical connection support that faces the unit stack.

28. The electrochemical device of claim 27, wherein:
the encapsulation system covers the opposite frontal faces of the unit stack, and the lateral faces of the stack which are not covered by the anode contact member and the cathode contact member, and
the encapsulation system further occupies all or part of the electrical insulation members and an intermediate space separating the electrical connection support from the first frontal face of the unit stack.

29. The electrochemical device of claim 26, wherein the sealing member comprises the anode contact member and/or the cathode contact member.

30. The electrochemical device of claim 29, further comprising a mechanical stiffening system to cover the encapsulation system opposite the electrical connection support.

31. The electrochemical device of claim 26, wherein:
the electrical connection support is a single-layer metal grid or a single-layer silicon interlayer,
the electrical insulation member comprises one or more free spaces made in the electrical connection support,
the free spaces are empty or filled with an electrically-insulating material, and
the two distant regions of the electrical connection support are placed on either side of the free spaces.

32. The electrochemical device of claim 31, wherein:
the electrical connection support comprises a single free space, and
the two distant regions of the electrical connection support are placed on either side of the free space.

33. The electrochemical device of claim 31, wherein the electrical connection support comprises two free spaces between which a central base plate of the electrical connection support is provided.

34. The electrochemical device of claim 26, wherein:
the electrical connection support is a multilayer printed circuit board comprising a plurality of layers disposed one below the other,
each layer of the multi-layer printed circuit board comprises at least one conductive zone and at least one insulating zone, and
the conductive zones of the layers forming electrical connection paths to connect the anode contact member and the cathode contact member respectively to the face of the electrical connection support which is opposite the unit stack.

35. The electrochemical device of claim 26, further comprising a rigid connection member to rigidly connect one of the frontal faces of the unit stack to the electrical connection support.

36. The electrochemical device of claim 35, wherein the rigid connection member comprises a layer of a non-conductive adhesive.

37. The electrochemical device of claim 26, wherein the anode contact member or the cathode contact member comprises a conductive adhesive.

38. The electrochemical device of claim 26, wherein the anode contact member or the cathode contact member comprises a metal foil.

39. A method of manufacturing an electrochemical device, the method comprising:
placing an electrical connection support, made at least in part of a conductive material, near a first frontal face of a unit stack formed by at least one unit cell, each unit cell successively including at least one anode current-collecting substrate, at least one anode layer, at least one layer of an electrolyte material or a separator impregnated with an electrolyte, at least one cathode layer, and at least one cathode current-collecting substrate, the unit stack defining six faces that includes two frontal faces opposite one another, generally parallel to the anode, electrolyte material and cathode layers, and four lateral faces opposite and parallel to one another in pairs;
insulating, via electrical insulation members, two distant regions of the electrical connection support from one another;
electrically connecting, via an anode contact member, the first lateral face of the unit stack to the electrical connection support;
electrically connecting, via a cathode contact member, the second lateral face of the unit stack, opposite the first lateral face, to the electrical connection support; and
coating the unit stack with a sealing member.

40. The method of claim 39, wherein the sealing member is coated after placing the electrical connection support near the first frontal face of the unit stack.

41. The method of claim 39, wherein at least part of the sealing member is coated before placing the electrical connection support near the first frontal face of the unit stack.

42. The method of claim 41, wherein:
at least one first layer of the sealing member is coated before placing the electrical connection support is placed near the first frontal face of the unit stack, and then
at least one second layer of the sealing member is coated after placing the electrical connection support near the first frontal face.

43. The method of claim 39, further comprising arranging a plurality of the unit stacks in a plurality of lines and/or a plurality of rows.

44. The method of claim 43, further comprising:
supplying a frame to form a plurality of supports;
placing the frame near the first frontal face of the plurality of the unit stacks; and
making a plurality of cuts in a longitudinal direction and/or a lateral direction of the plurality of stacks to form a plurality of electrochemical devices.

45. An electric energy-consuming device, comprising:
a body; and
an electrochemical device, fastened to the body, to supply electric energy to the electric energy-consuming device, the electrical connection support including:
a unit stack formed by at least one unit cell, each unit cell successively including at least one anode current-collecting substrate, at least one anode layer, at least one layer of an electrolyte material or a separator impregnated with an electrolyte, at least one cathode layer, and at least one cathode current-collecting substrate, the unit stack defining six faces that includes two frontal faces opposite one another, generally parallel to the anode, electrolyte material and cathode layers, and four lateral faces opposite and parallel to one another in pairs;
an anode contact member;
a cathode contact member;
a sealing member to protect the unit stack;
an electrical connection support, made at least in part of a conductive material, provided near a first frontal face of the unit stack; and
electrical insulation members to insulate two distant regions of the electrical connection support from one another,
wherein:
the anode contact member electrically connects a first lateral face of the unit stack to the electrical connection support, and
the cathode contact member electrically connects a second lateral face of the unit stack, opposite the first lateral face, to the electrical connection support.
